(19) United States
(12) Patent Application Publication
(10) Pub. No.: US 2005/0139525 A1
(43) Pub. Date: Jun. 30, 2005

(54) Chip sorting apparatus and method for fabricating the same

(76) Inventors: Tung-Hung Tsai, Tucheng City (TW); Shyang-Li Wang, Tucheng City (TW); Chia-Wei Wu, Tucheng City (TW); Jhih-Jhong Huang, Tucheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/722,507

(22) Filed: Nov. 28, 2003

(51) Int. Cl. B07C 5/344; B07C 5/00

(52) U.S. Cl. 209/571

(57) ABSTRACT

A chip sorting apparatus and a method for fabricating the same are applicable to the chip pick-up sorting process after chip formation. By using the chip sorting apparatus and the method for fabricating the same in the chip pick-up process, it can directly inspect the chip without multiple chip movements for implementing the chip inspection. The chip sorting apparatus and the method for fabricating the same use a positioning axis to directly process inspection on the chip before picking up the chip. This, therefore, can avoid the complicated process causing from multiple chip pick-up positions. Further, it can enhance the chip pick-up efficiency.

### FIELD OF THE INVENTION

The present invention is to provide a chip sorting apparatus and the method for fabricating the same. More particularly, it is applicable to the chip pick-up sorting process. By using the chip sorting apparatus and the method for fabricating the same of the present invention, it can fast implement the chip inspection without multiple chip re-movements. Further, it can avoid multiple positions before the chip inspection.

### BACKGROUND OF THE INFORMATION

In the conventional chip sorting inspection process, it picks up the chip from the wafer and places it to a supporting plate. Then, it picks up the chip in order from the supporting plate and places them to a testing platform. Please referring to FIG. 1, it is a prior art showing the flow chart of the chip pick-up inspection. First, it picks the chip up 20 from the wafer 10, and places it to a supporting plate 30. Then, it uses a pick-up method to pick up the chip 20 from the supporting plate 30 for processing the inspection in the testing platform. However, the chip has to pass through multiple movements before testing. The chip, therefore, has to be performed for positioning before testing. It has to process positioning in both Y direction 41 and X direction 42. More, it has to pass through at least a three-pin position in the positioning process for further inspection.

According to the above description, the present invention is to provide a chip sorting apparatus and a method for fabricating the same. It uses a positioning axis to process directly the chip sorting inspection on the wafer. More, it does not require multiple chip re-movements as well as not require multiple positions to achieve the chip inspection. The positioning axis leads to a fast position while picking up the chip. It can avoid the complicated processes of multiple chip positions causing from multiple pick-ups. Further, it can enhance the chip pick-up efficiency.

### SUMMARY OF THE INVENTION

It is an object of the present invention is to provide a chip sorting method. More particularly, it is applicable to the chip pick-up sorting process. By using the chip sorting method to directly inspect the chip in the chip pick-up process, it does not require multiple chip re-movements and can implement the chip inspection. The chip sorting method mainly uses a direct inspection on the chip of the wafer. More particularly, it uses a positioning axis to remove the chip from wafer and to process the inspection. More, it does not require multiple chip pick-ups and repeat positions thereto enhance the chip pick-up efficiency.

It is another object of the present invention is to provide a chip sorting apparatus. More particularly, it is applicable to the chip pick-up process. By using the chip sorting apparatus, it can directly inspect the chip in the chip pick-up process. It does not require multiple chip re-movements, and can implement the chip inspection. The chip sorting apparatus mainly comprises two chip pick-up platforms and one positioning axis. It directly processes the chip inspection on the wafer, then, it does not require removing the chip from the wafer and then processes the inspection. Therefore, it can decrease multiple pick-ups and repeat positions for the chip thereto enhance the chip sorting efficiency.

For a more complete understanding of the present invention and for further advantages thereof, reference is now made to the following description taken in conjunction with the accompanying drawing, in which:

### BRIEF DESCRIPTION OF THE DRAWINGS

FIG. 1 is a prior art showing the flow chart of the chip pick-up inspection;

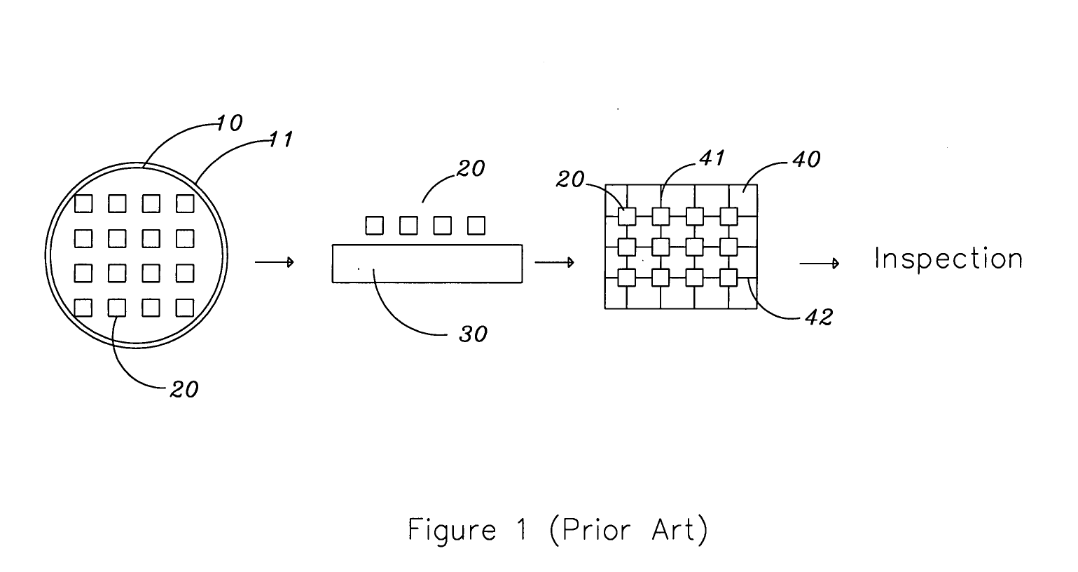

FIG. 2 is a preferred embodiment of the present invention showing a chip sorting apparatus;

FIG. 3 is a preferred embodiment of the present invention showing a chip sorting process; and

FIG. 4 is a preferred embodiment of the present invention showing the flow chart of the chip sorting method.

### DETAILED DESCRIPTION OF THE PREFERRED EMBODIMENTS

The present invention is to provide a chip sorting apparatus and the method thereof. More particularly, it is applicable to the chip pick-up sorting process. By using the chip sorting method to directly inspect the chip in the chip pick-up process, it does not require multiple chip re-movements and can implement the chip inspection.

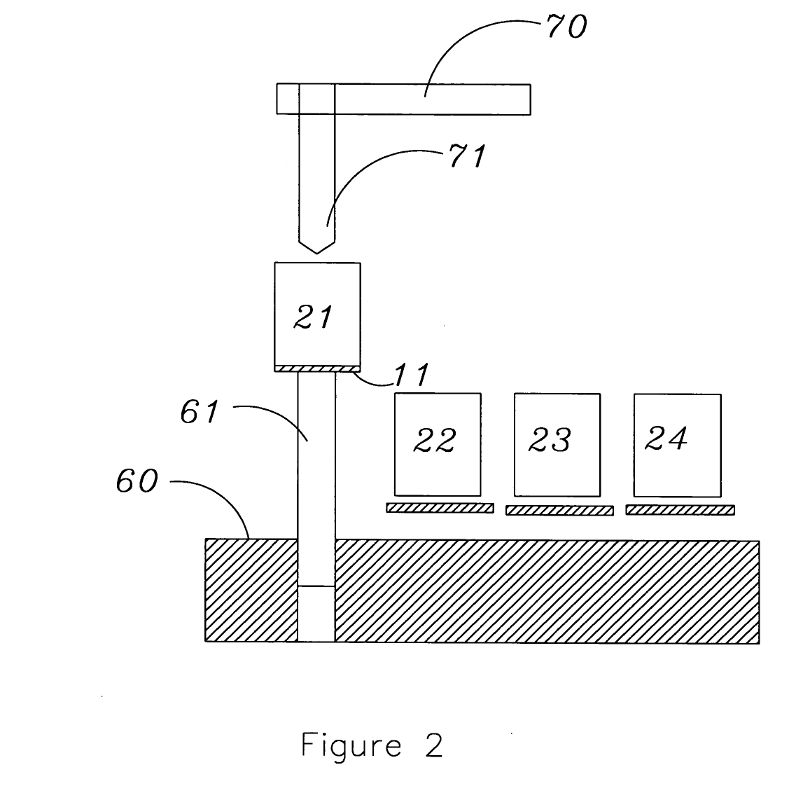

Please referring to FIG. 2, it is a preferred embodiment of the present invention showing a chip sorting apparatus. The chip sorting apparatus comprises a first platform 60, which provides a place for the wafer. The wafer 10 comprises at least a chip 21. A positioning axis 61 is also included, which is positioned under the first platform 60, and comprises a withstand-end 611 with lift and down functions. A first robotic arm 70 is included, which has a probe 71. The withstand-end 611 can withstand the chip 21 by lift and down. It uses the probe to process the electricity test for testing the chip 21. It follows the test of the probe 71, and places the chip to the pre-sorting specialized bin of the second platform. Apart from this, while the wafer 10 comprises at least two more chips 20, the wafer 10 is placed in the first platform 60. The wafer is pre-cut for dividing the chip 20, and processes the chipping on the blue film 11 of the chip.

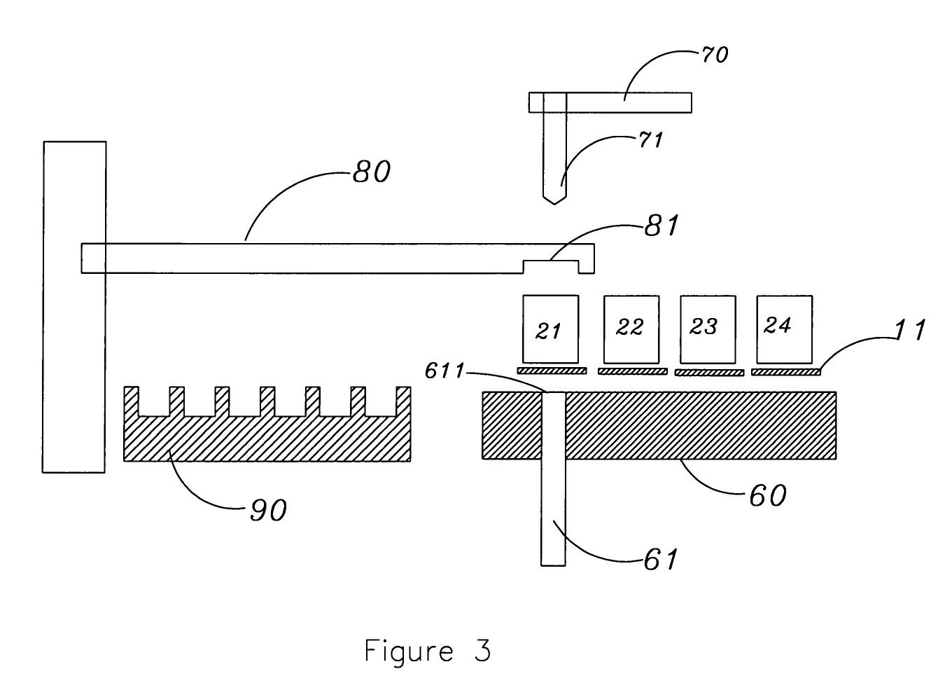

Please referring to FIG. 3, it is a preferred embodiment of the present invention showing a chip sorting process. The chip sorting apparatus further comprises a second robotic arm 80 and a second platform 90. The second robotic arm 80 having a sucking mechanism 81 sucks the chip 21 and places it to the specialized bin of the second platform 90. The specialized bin more can be used for sorting different kinds of chips.

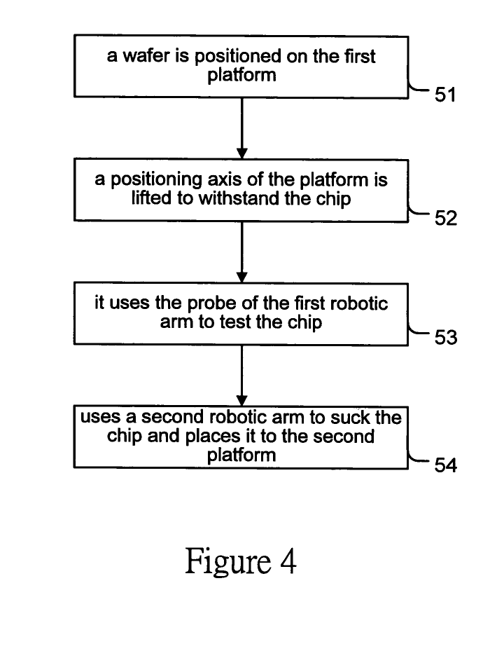

Furthermore, the present invention is to provide a chip sorting method. Please referring to FIG. 4, it is one of the preferred embodiments in the present invention showing the flow chart of a chip sorting method. The chip sorting method can be described as the followings. First, a wafer is positioned on the first platform 51. The wafer at least is covered with a chip and a blue film. While the wafer has at least two chips, it processes the wafer division and blue film chipping for dividing the chip. Further, a positioning axis of the platform is lifted to withstand the chip 52. Then, it uses the probe of the first robotic arm to test the chip 53. The test can include an electricity test of the chip inspection. Finally, it uses a second robotic arm to suck the chip and places it to the second platform 54. The second platform at least comprises a specialized bin, and the specialized bin is for pre-sorting. Other objects, features, and advantages of the present invention will become more fully apparent from the following detailed description of the preferred embodiments, the appended claims, and the accompanying drawings.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims while which are to be accord with the broadest interpretation so as to encompass all such modifications and similar structures.

1. A chip sorting method, comprising the steps of;
(a) having a wafer on the first platform, said wafer at least comprises a chip;
(b) lifting up a positioning axis of said first platform to withstand said chip;
(c) using a probe of said robotic arm to inspect said chip; and
(d) using a second robotic arm to suck said chip, and to place it to the second platform.

2. The method according to claim 1, wherein said second platform at least comprises a specialized bin.

3. The method according to claim 1, wherein said test can include an electricity test for inspecting the said chip.

4. The method according to claim 2, wherein said step(d) further includes the test following step(c), and it places the chip to said pre-sorting specialized bin.

5. The method according to claim 1, wherein said step(a) further includes pre-cutting said wafer for dividing said chip.

6. The method according to claim 1, wherein said step(a) further includes said wafer processing the chipping on the blue film after cutting.

7. A chip sorting apparatus, comprising;
a first platform providing a place for wafer, and said wafer at least including a chip;
a positioning axis setting under the first platform, and having a withstand-end for lift and down;
a first robotic arm having a probe;
a second robotic arm having a sucking mechanism; and
a second platform providing the place for said chip;
wherein said withstand-end can use lift-down to withstand said chip, It uses said probe to inspect the said chip, and then, it uses said sucking mechanism to suck the chip, and places it to said second platform.

8. The apparatus according to claim 7, wherein said second platform at least includes a specialized bin.

9. The apparatus according to claim 7, wherein said test can include an electric test for inspecting said chip.

10. The apparatus according to claim 8, wherein it can rely on the test of said probe, and place the chip to said pre-sorting specialized bin.

11. The apparatus according to claim 7, wherein said wafer is positioned on said first platform and is pre-cut for dividing said chip.

12. The apparatus according to claim 11, wherein said wafer setting in the said platform, and said wafer is positioned on the blue film and processes a chipping after being cut.
